(19) United States
(12) Patent Application Publication
(10) Pub. No.: US 2009/0118978 A1
(43) Pub. Date: May 7, 2009

(54) COMBUSTION CONTROL SYSTEM OF A DIESEL ENGINE

(75) Inventors: Keiki TANABE, Kawasaki-shi (JP); Shinji NAKAYAMA, Kawasaki-shi (JP); Fumitaka KOMATSU, Kawasaki-shi (JP); Keiichi OKUDE, Kawasaki-shi (JP); Shiroh SHIINO, Kawasaki-shi (JP)

Correspondence Address: ROSSI, KIMMS & McDOWELL LLP., 20609 Gordon Park Square, Suite 150, Ashburn, VA, 20147, US

(73) Assignee: MITSUBISHI FUSO TRUCK AND BUS CORPORATION, Kawasaki-shi (JP)

(21) Appl. No.: 12/262,775

(22) Filed: Oct. 31, 2008

(30) Foreign Application Priority Data
Nov. 1, 2007 (JP) 2007-285065
Nov. 16, 2007 (JP) 2007-298029

(51) Int. Cl. F02D 45/00

(52) U.S. Cl. 701/103

(57) ABSTRACT

A combustion control system of a diesel engine, which controls a fuel-injection timing by switching from one to another of a normal combustion mode, a premix combustion mode, and a transition mode of between these modes, and switches from the normal combustion mode to the transition mode if an intake oxygen density is equal to or lower than a predetermined value in the normal combustion mode.

### BACKGROUND OF THE INVENTION

1. Field of the Invention

The present invention relates to a combustion control system of a diesel engine, and more specifically, to a technology of controlling fuel injection by switching between a premix combustion mode and a normal combustion mode.

2. Description of the Related Art

As to the combustion control of a diesel engine, there is a well-known technology that switches between a normal combustion mode that injects fuel near the top dead center of a piston and carries out ignition during the fuel injection and a premix combustion mode that finishes the fuel injection before a fuel-autoignition timing and then carries out ignition.

In the normal combustion mode, the fuel is additionally supplied even after ignition, so that a fuel supply amount into cylinders is increased, and high output can be secured. In the premix combustion mode, ignition is carried out after the fuel injection is finished, and an air-fuel mixture is fully diluted and homogenized. This suppresses a local increase of combustion temperature and reduces a generation amount of NOx (nitrogen oxides). In general, combustion control is carried out in the premix combustion mode during a low-speed and low-load operation or during an idling operation in consideration of exhaust performance, and in the normal combustion mode during other operations in consideration of output performance.

In a certain case, target values of control parameters of fuel-injection timings and the like are specified in maps or the like for the premix and normal combustion modes. At the time of a switching transition between the premix combustion mode and the normal combustion mode, the combustion control is carried out to gradually vary the target values of the control parameters so that two maps corresponding to the respective modes are linked to each other (see Unexamined Japanese Patent Application Publication No. 2006-105046).

The combustion control disclosed in the publication is carried out so as to simply link the map for the premix combustion mode and that for the normal combustion mode to each other. If this combustion control is employed, proper fuel injection is difficult to be performed, for example, in an engine having an EGR system due to a delay in operation of the EGR system during a time period of the switching transition between the combustion modes (during a transition mode). This might cause smoke and a torque shock, and also might produce NOx.

An exhaust purification catalyst that traps NOx contained in exhaust gas to reduce and remove the NOx is generally interposed in the exhaust path of a diesel engine. On the other hand, if the exhaust purification catalyst is in an inactive state as seen immediately after cold start, NOx is discharged outside, instead of being fully removed by the exhaust purification catalyst.

### SUMMARY OF THE INVENTION

The present invention has been made to solve the foregoing problems. It is an object of the invention to provide a combustion control system of a diesel engine, which suppresses the generation of smoke and a torque shock by performing proper fuel injection at the time of a switching transition between a premix combustion mode and a normal combustion mode to enable a smooth transition, and is capable of suppressing NOx from being discharged even if an exhaust purification catalyst is in an inactive state.

In order to accomplish the above object, the combustion control system of a diesel engine according to the invention controls a fuel-injection timing by switching from one to another of a normal combustion mode that carries out ignition within a fuel-injection period, a premix combustion mode that carries out ignition subsequently to a premix period after the fuel injection is finished, and a transition mode in which an engine is transited between the normal combustion mode and the premix combustion mode. The combustion control system has control means that switches from the normal combustion mode to the transition mode if an intake oxygen density is equal to or lower than a predetermined value in the normal combustion mode.

Since the fuel-injection timing is controlled by switching between the normal combustion mode and the transition mode from one to the other according to the intake oxygen density, for example, even if an EGR system of a diesel engine delays in responding to a change of an engine operational state, it is possible to set a proper fuel-injection timing appropriate to an intake state, and then to suppress the generation of smoke.

The combustion control system of a diesel engine according to the invention has catalyst's state-estimation means that estimates whether an exhaust purification catalyst for removing the nitrogen oxides contained in exhaust gas of the diesel engine is in an inactive state, and the control means selects the map for the low emission mode when the catalyst's state-estimation means estimates that the exhaust purification catalyst is in the inactive state.

Consequently, even if the exhaust purification catalyst is in the inactive state as seen immediately after cold start, the nitrogen oxides can be suppressed from being discharged.

### BRIEF DESCRIPTION OF THE DRAWINGS

The present invention will become more fully understood from the detailed description given hereinafter and the accompanying drawings which are given by way of illustration only, and thus, are not limitative of the present invention, and wherein:

FIG. 1 is a flowchart showing a procedure of determining the switching of combustion modes in a combustion control system according to a first embodiment of the invention;

FIG. 2 shows a map for determining a combustion mode;

FIG. 3 is a block diagram showing a calculation process of a fuel-injection timing in a transition mode according to the first embodiment;

FIG. 4 shows a map for calculating a fuel-injection timing in a low smoke mode;

FIG. 5 shows a map for calculating a fuel-injection timing in a low emission mode;

FIG. 6 is a reference figure showing a relationship between fuel-injection timings and intake oxygen densities, and also showing a difference of transition paths of the fuel-injection timing between the low smoke mode and the low emission mode;

FIG. 7 is a graph showing a relationship of the fuel-injection timings, the intake oxygen densities, and the smoke densities within exhaust gas;

FIG. 8 is a graph showing a relationship of the fuel-injection timings, the intake oxygen densities, and NOx densities within exhaust gas;

FIG. 9 is a graph showing a relationship of the fuel-injection timings, the intake oxygen densities, and engine output torques;

FIG. 10 is a flowchart showing the procedure of determining the switching of combustion modes in a combustion control system of a second embodiment of the invention;

FIG. 11 is a block diagram showing a calculation process of a fuel-injection timing and accelerator opening in a transition mode according to the second embodiment; and

FIG. 12 is a map for calculating corrective accelerator opening.

### DETAILED DESCRIPTION OF THE PREFERRED EMBODIMENTS

Embodiments of the invention will be described below with reference to the attached drawings.

Firstly, a first embodiment will be described.

In an exhaust path of a diesel engine (hereinafter, referred to as engine) having a combustion control system according to the first embodiment of the invention, there is interposed a NOx catalyst (exhaust purification catalyst) that traps NOx (nitrogen oxides) contained in exhaust gas to reduce the NOx into harmless substances. The engine is provided with an EGR system and a common rail system. The EGR system includes an EGR path that connects the exhaust path and an intake path to each other. The EGR system has a function of suppressing the generation of NOx by opening/closing an EGR valve interposed in the EGR path to return a portion of the exhaust gas into intake air, thereby reducing combustion temperature.

The common rail system stores in a common rail the fuel that is highly pressurized with a fuel pump. The common rail system supplies the high-pressure fuel from the common rail to injectors of cylinders, and injects the fuel into the cylinders. The pressure in the common rail can be adjusted by controlling the operation of the fuel pump. The injectors are controlled in operation by the combustion control system, so that a fuel injection amount and fuel-injection timing into each of the cylinders are controlled.

The combustion control system has a function of inputting various engine operational states and switching the fuel injection using the injectors to a normal combustion mode or a premix combustion mode.

In the normal combustion mode, it is controlled such that the fuel injection is carried out near a top dead center of a piston, and the fuel is additionally supplied even after ignition. A fuel supply amount into each of the cylinders is accordingly increased, so that high output can be achieved. In the premix combustion mode, it is controlled such that the fuel injection is finished before a fuel-autoignition timing. The ignition is carried out after the fuel injection is finished, and an air-fuel mixture is fully diluted and homogenized, to thereby suppress a local increase of combustion temperature and reduce a NOx generation amount. Between the normal and premix combustion modes, there is a transition mode that is a transition period between these two modes.

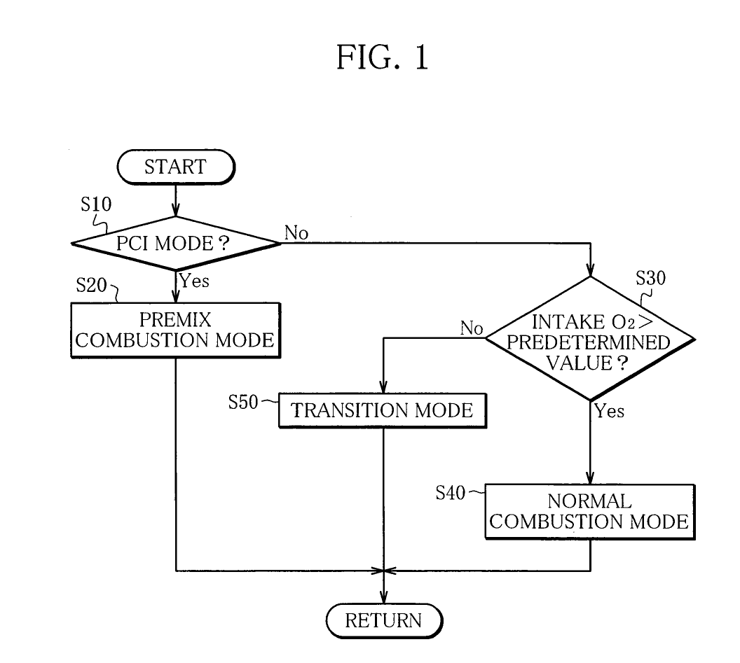

FIG. 1 is a flowchart showing the procedure of determining the switching between combustion modes according to the first embodiment of the invention. This routine is repeatedly implemented while the engine is operated.

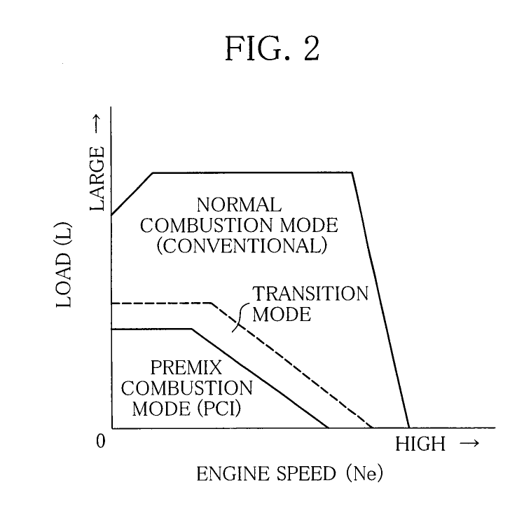

As shown in FIG. 1, Step S10 first inputs engine speed Ne and load L (fuel injection amount, for example), and makes a determination as to whether an operational state is appropriate to the premix combustion mode, on the basis of a prestored combustion-mode determination map as shown in FIG. 2. If it is determined that the operational state is appropriate to the premix combustion mode, the routine advances to Step S20. In the above map, it is set such that the premix combustion (PCI) mode is selected during a low speed and load time, and that the normal combustion (Conventional) mode is selected in other zones. A zone between the premix combustion mode and the normal combustion mode corresponds to the transition mode.

Step S20 selects the premix combustion mode. The routine then returns to start.

If Step S10 determines that an engine operational condition is not appropriate to the premix combustion mode, the routine proceeds to Step S30.

Step S30 makes a determination as to whether an intake oxygen density is higher than a predetermined value. If the intake oxygen density is higher than the predetermined value, the routine moves to Step S40. The predetermined value may be set, for example, at a lower limit value that enables normal combustion.

Step S40 selects the normal combustion mode. The routine then returns.

If Step S30 determines that the intake oxygen density is equal to or lower than the predetermined value, the routine advances to Step S50.

Step S50 selects the transition mode. The routine then returns.

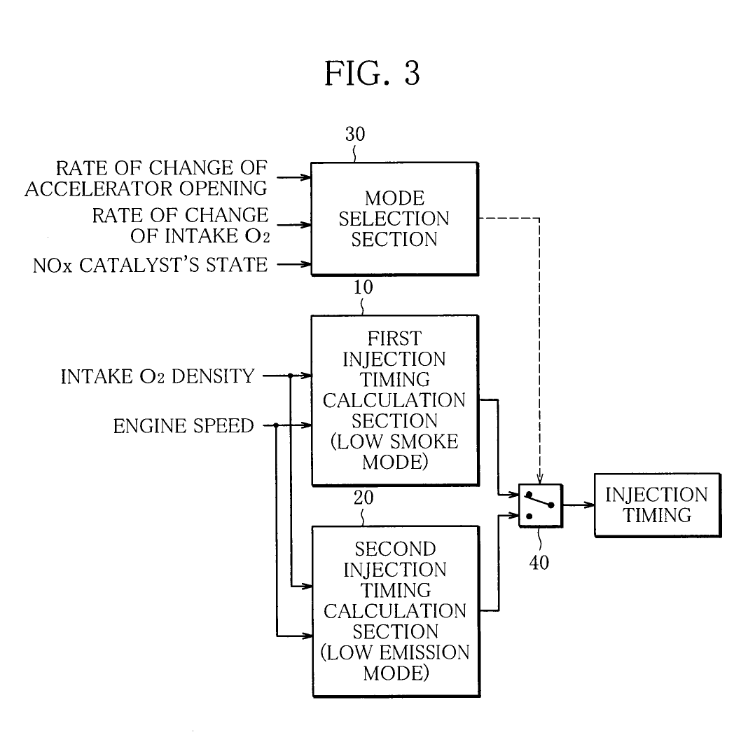

A calculation process of a fuel-injection timing in the transition mode will be described below with reference to a block diagram shown in FIG. 3 according to the first embodiment.

The combustion control system sets the fuel-injection timing in the transition mode according to the intake oxygen density. To be concrete, the combustion control system has two maps in which fuel-injection timings corresponding to intake oxygen densities are specified, and implements control for switching these maps according to the engine operational state (control means).

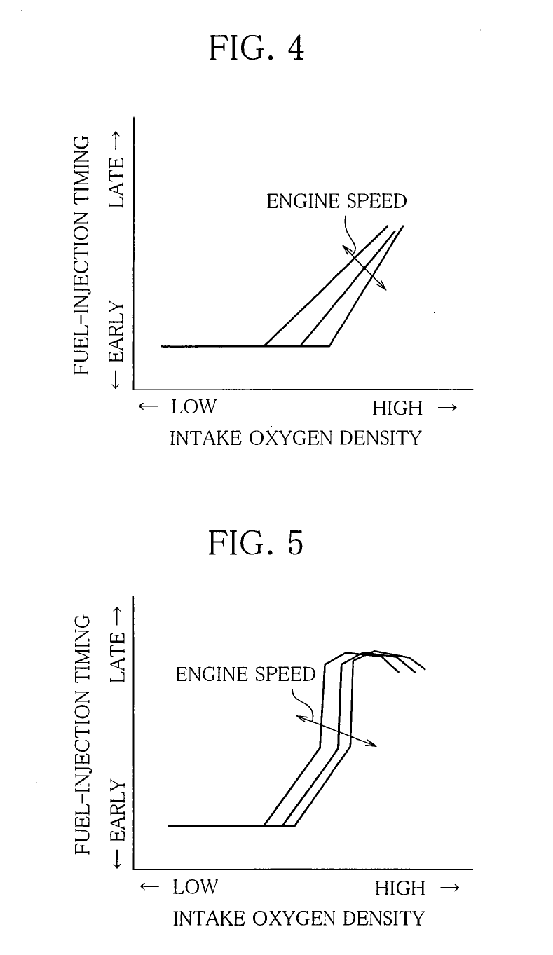

As shown in FIG. 3, a first injection-timing calculation section 10 inputs the intake oxygen density and the engine speed, and calculates the fuel-injection timing for a low smoke mode. The fuel-injection timing in the low smoke mode is determined by using a map as shown in FIG. 4. A second injection-timing calculation section 20 inputs the intake oxygen density and the engine speed, and calculates the fuel-injection timing in a low emission mode. The fuel-injection timing in the low emission mode is determined by using a map as shown in FIG. 5. In FIGS. 4 and 5, it is set such that the fuel-injection timing is delayed along with an increase of the intake oxygen density, and that the fuel-injection timing is varied in response to a change of the engine speed.

A mode selection section 30 inputs a rate of change of accelerator opening, a rate of change of the intake oxygen density, and, for example, catalyst temperature of the exhaust purification catalyst as a measure of a NOx catalyst's state. The mode selection section 30 subsequently determines a mode to be selected between the low emission mode and the low smoke mode. It may be set such that the low emission mode is selected if the rate of change of the accelerator opening and that of the intake oxygen density are low, or if the NOx catalyst is in an inactive state due to low catalyst temperature, and that the low smoke mode is selected if the rate of change of the accelerator opening and that of the intake oxygen density are high, or if the NOx catalyst is in an active state.

A switching section 40 outputs a value calculated by the injection-timing calculation section 10 or 20, which corresponds to the mode selected by the mode selection section 30, as a final fuel-injection timing.

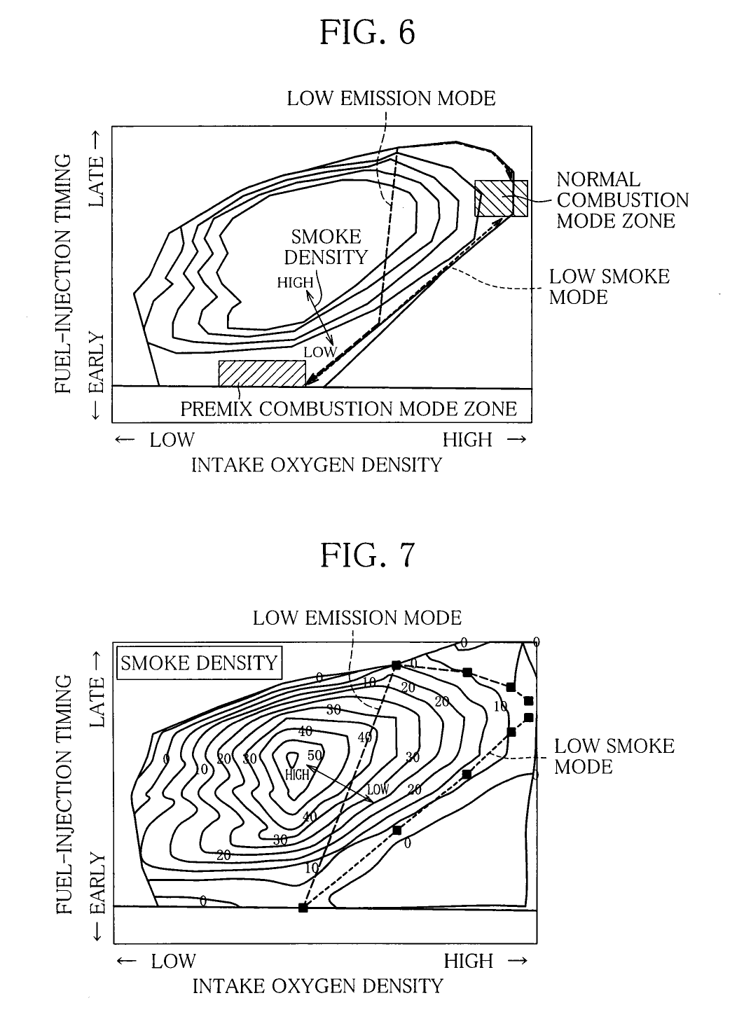

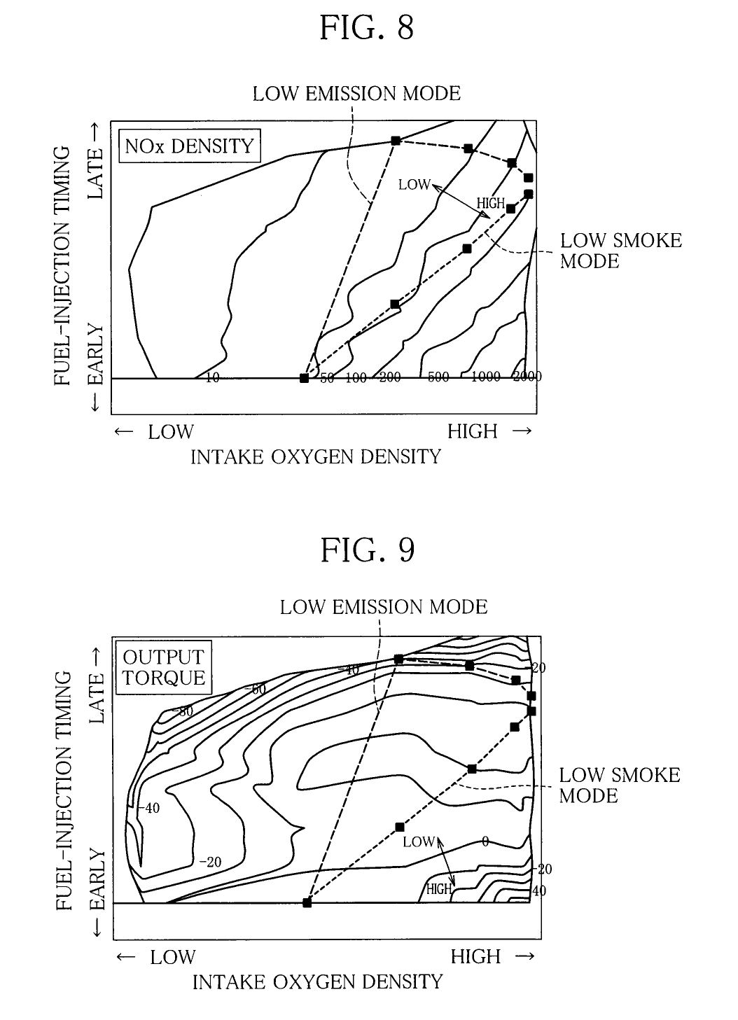

FIG. 6 is a graph showing a relationship between intake oxygen densities and fuel-injection timings, and is also a reference figure showing a difference of transition paths of the low emission mode and the low smoke mode. Smoke density is shown as contour lines in FIG. 6 for reference. The smoke density is high in a central part of the figure. FIG. 7 is a graph showing a relationship of the intake oxygen densities, the fuel-injection timings, and smoke densities. In the figure, a larger number indicates a higher smoke density. FIG. 8 is a graph showing a relationship of the intake oxygen densities, the fuel-injection timings, and NOx densities. In the figure, a larger number indicates a higher NOx density. FIG. 9 is a graph showing a relationship of the intake oxygen densities, the fuel-injection timings, and output torques. In the figure, a larger number indicates a higher output torque.

As shown in FIG. 6, in the transition mode, transition is made between a zone of the premix combustion mode, which is located in a lower part of the figure, and a zone of the normal combustion mode, which is located in the upper right part of the figure. Transition paths are different between the low emission mode and the low smoke mode. In the low smoke mode, in consideration of characteristics of the smoke density shown in FIG. 7, it is set such that the zone of the premix combustion mode and that of the normal combustion mode are linked to each other with a substantially straight line so as to avoid zones in which the smoke density is high. In the low emission mode, in consideration of characteristics of the NOx density shown in FIG. 8, it is set such that the transition is made in zones where the NOx density is low as much as possible. As shown in FIG. 9, the engine output torque has such a characteristic that it is hardly affected by the intake oxygen density in between the premix combustion mode and the normal combustion mode, and is changed according to the fuel-injection timing. Since inclination (ratio of the fuel-injection timing to the intake oxygen density) is set smaller in the low smoke mode than in the low emission mode as shown in FIG. 9, the change of the fuel-injection timing becomes smaller than that of the intake oxygen density. Accordingly, the change of the output torque also becomes small. As shown in FIG. 9, the engine output torque has such a characteristic that it is increased when the fuel-ignition timing is early (advanced). Since the fuel-injection timing is set earlier in the low smoke mode than in the low emission mode at the same intake oxygen density, the engine output torque can be maintained high during the transition between the premix and normal combustion modes.

In the present embodiment, the switching between the normal combustion mode and the transition mode, and the fuel-injection timing in the transition mode, are set according to the intake oxygen density as stated above. This makes it possible to set an accurate fuel-injection timing that is appropriate to an intake state, for example, even if the EGR system delays in response. Consequently, smoke can be suppressed from being generated.

As maps used for setting the fuel-injection timings, two maps for the low emission mode and the low smoke mode are prepared. When the accelerator opening is rapidly changed, or when the catalyst temperature of the NOx catalyst is fully increased, the low smoke mode is selected. Accordingly, the smoke generation and the output torque fluctuation are both suppressed, which enables a smooth transition. If the change of the accelerator opening and that of the intake oxygen density are small, the smoke generation and the output torque fluctuation are unlikely to take place. On this account, the NOx generation can be suppressed by selecting the low emission mode as mentioned above. In other words, the present embodiment properly sets the fuel-injection timing according to various operational conditions in the transition mode, thereby suppressing the smoke generation and the output torque fluctuation and also suppressing the NOx generation as well.

A second embodiment will be described below.

Unlike the first embodiment, in a combustion control system according to the second embodiment of the invention, the low emission mode and the low smoke mode are switched from one to the other according to whether the NOx catalyst is in the inactive state, and the accelerator opening is restricted so that the low emission mode is selected when the NOx catalyst is in the inactive state. The following description of the second embodiment will focus on the differences from the first embodiment.

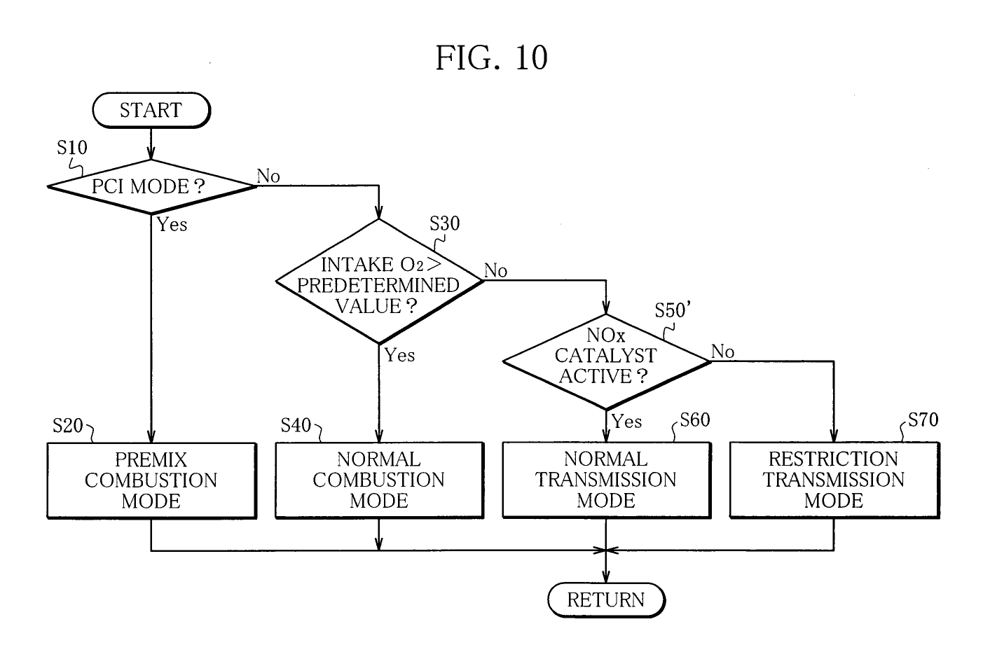

FIG. 10 is a flowchart showing the procedure of determining the switching between combustion modes according to the second embodiment of the invention. Steps S10 to S40 of the flowchart are the same as those in the first embodiment, so that the description thereof will be omitted.

Step S50′ makes a determination as to whether the NOx catalyst is in an active state. If the NOx catalyst is in the active state, the routine moves to Step S60.

Step S60 selects a normal transition mode among transition modes. The routine then returns.

If Step S50′ determines that the NOx catalyst is not in the active state, namely, in the inactive state, the routine proceeds to Step S70.

Step S70 selects a restriction transition mode among the transition modes. The routine then returns.

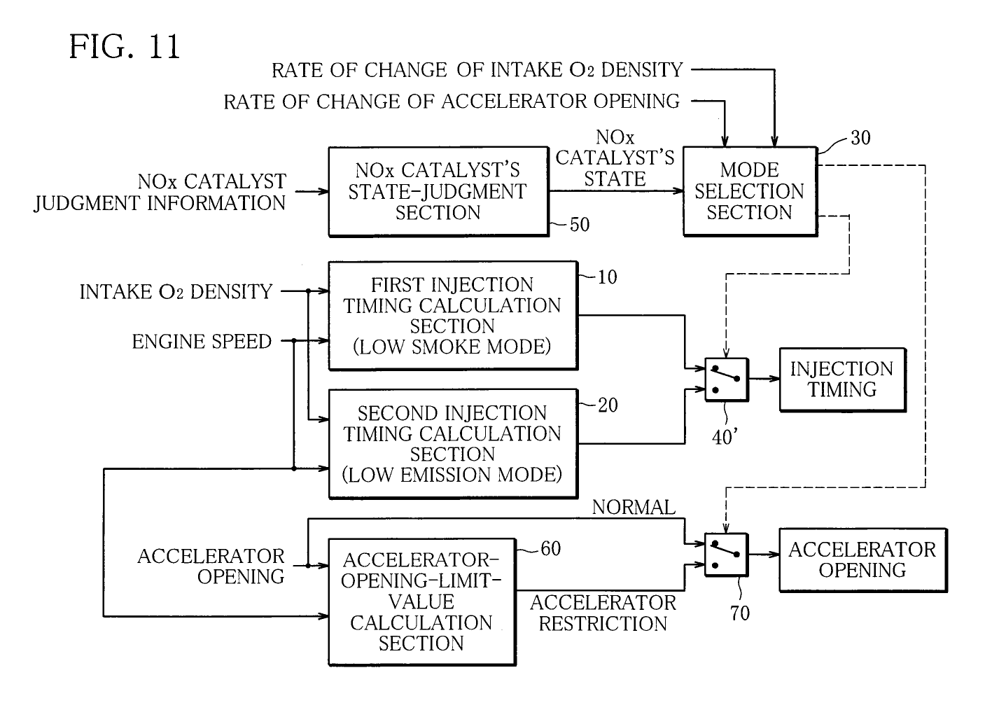

A calculation process of a fuel-injection timing and accelerator opening in the transition mode will be described below with reference to a block diagram shown in FIG. 11. In this block diagram, a first injection-timing calculation section 10 and a second injection-timing calculation section 20 are identical to those of the first embodiment, so that the description thereof will be omitted.

A NOx catalyst's state-judgment section 50 (catalyst's state-estimation means) inputs NOx catalyst judgment information and determines whether the NOx catalyst is in the active state. The NOx catalyst judgment information is sufficient if it enables estimation as to whether the NOx catalyst is in the inactive state. The information may include, for example, catalyst temperature of the NOx catalyst and a supply state of a reducing agent into the NOx catalyst.

The mode selection section 30 inputs a judgment result of the NOx catalyst's state from the NOx catalyst's state-judgment section 50, and inputs a rate of change of accelerator opening and a rate of change of an intake oxygen density. The mode selection section 30 then determines a mode to be selected between a low emission mode and a low smoke mode. It may be set such that the low emission mode is selected if the rate of change of the accelerator opening and that of the intake oxygen density are low, or if the NOx catalyst is in the inactive state, and that the low smoke mode is selected if the rate of change of the accelerator opening and that of the intake oxygen density are high, or if the NOx catalyst is in the active state.

A first switching section 40′ outputs a value calculated by the injection-timing calculation section 10 or 20, which corresponds to the mode selected by the mode selection section 30, as a final fuel-injection timing.

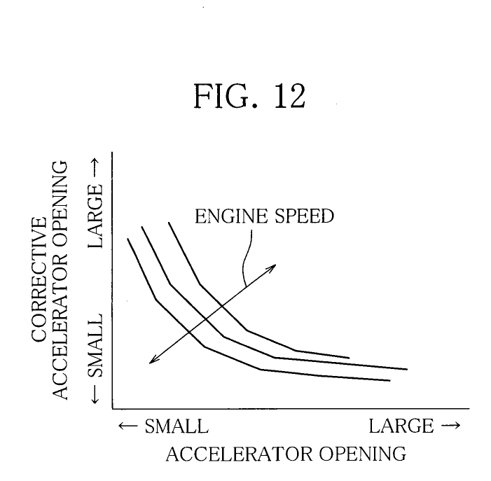

An accelerator-opening-limit-value calculation section 60 inputs the accelerator opening and engine speed, and calculates corrective accelerator opening. The corrective accelerator opening is found by using a map as shown in FIG. 12. In FIG. 12, an upper limit value of the accelerator opening based upon the engine speed is set such that the low emission mode is selected by the mode selection section 30.

A second switching section 70 inputs a judgment result of the NOx catalyst's state from the NOx catalyst's state-judgment section 50 through the mode selection section 30. If the NOx catalyst is in the active state, the second switching section 70 directly outputs the accelerator opening as a final accelerator opening without correcting the same. If it is determined that the NOx catalysts is in the inactive state, the second switching section 70 outputs as a final accelerator opening the corrective accelerator opening that is calculated by the accelerator-opening-limit-vale calculation section 60.

According to the second embodiment, especially when the NOx catalyst is in the inactive state during the transition mode, the low emission mode is forcibly selected. Consequently, the second embodiment not only has the same operation and advantages as those of the first embodiment but also suppresses the NOx generation in the engine. The second embodiment is therefore capable of suppressing the NOx discharge even if the NOx catalyst is in the inactive state. Furthermore, if the NOx catalyst is in the inactive state during the transition mode, the accelerator opening is suppressed so that the low emission mode is maintained. In result, a rapid change of an intake state is suppressed. This surely suppresses the generation of nitrogen oxides, attributable to a delay of the proper injection timing in relation to the intake oxygen density.

When the exhaust purification catalyst is in the inactive state, the second embodiment carries out both the forcible switching to the low emission mode and the restriction on the accelerator opening. The present invention, however, is not limited to this, and may carries out only either one of the forcible switching to the low emission mode and the restriction of the accelerator opening.

In the second embodiment, the mode selection section 30 selects either the map for the low emission mode or the map for the low smoke mode according to the rate of change of the accelerator opening, the rate of change of the intake oxygen density, and the catalyst temperature as a measure of the NOx catalyst's state. However, the invention is not limited to this, and may properly selects either one of the maps over the other according to information that enables an estimation as to whether the engine is in a transient operational state or as to whether the NOx catalyst is in the active state.

What is claimed is:

1. A combustion control system of a diesel engine, which controls a fuel-injection timing by switching from one to another of a normal combustion mode that carries out ignition within a fuel-injection period, a premix combustion mode that carries out ignition subsequently to a premix period after fuel injection is finished, and a transition mode in which an engine is transited between the normal combustion mode and the premix combustion mode, the combustion control system comprising:
control means that switches from the normal combustion mode to the transition mode if an intake oxygen density is equal to or lower than a predetermined value in the normal combustion mode.

2. The combustion control system of a diesel engine according to claim 1, wherein:
the control means has a plurality of maps for the transition mode, in which fuel-injection timings corresponding to intake oxygen densities are specified, and controls the fuel-injection timing during the transition mode by selecting and using any one of the maps according to an engine operational state.

3. The combustion control system of a diesel engine according to claim 2, wherein:
the control means has, as the maps, a map for a low emission mode that suppresses nitrogen oxides from being discharged and a map for a low smoke mode that suppresses smoke from being discharged, and also suppresses a fluctuation of output torque in relation to a change of the intake oxygen density.

4. The combustion control system of a diesel engine according to claim 3, wherein:
the fuel-injection timing specified in the map for the low smoke mode is more advanced than the fuel-injection timing in the map for the low emission mode at the same intake oxygen density.

5. The combustion control system of a diesel engine according to claim 3, wherein:
catalyst's state-estimation means that estimates whether an exhaust purification catalyst for removing the nitrogen oxides contained in exhaust gas of the diesel engine is in an inactive state, the combustion control system wherein:
the control means selects the map for the low emission mode when the catalyst's state-estimation means estimates that the exhaust purification catalyst is in the inactive state.

6. The combustion control system of a diesel engine according to claim 5, wherein:
restriction means that restricts accelerator opening so that the low emission mode is selected according to the engine operational state in the control means when the catalyst's state-estimation means estimates that the exhaust purification catalyst is in the inactive state.

7. The combustion control system of a diesel engine according to claim 3, wherein:
the control means selects either one of the map for the low emission mode and the map for the low smoke mode according to a rate of change of accelerator opening, a rate of change of the intake oxygen density, and catalyst temperature of the exhaust purification catalyst as a measure of the engine operational state.
